(19) United States
(12) Patent Application Publication
(10) Pub. No.: US 2020/0242338 A1
(43) Pub. Date: Jul. 30, 2020

(54) IMAGE PROCESSING APPARATUS FOR SEARCHING IMAGE DATABASE TO EXTRACT IMAGE SIMILAR TO DESIGNATED IMAGE

(71) Applicant: KYOCERA Document Solutions Inc., Osaka (JP)

(72) Inventor: Takanori SHIRAISHI, Osaka (JP)

(73) Assignee: KYOCERA Document Solutions Inc., Osaka (JP)

(21) Appl. No.: 16/751,816

(22) Filed: Jan. 24, 2020

(30) Foreign Application Priority Data
Jan. 29, 2019 (JP) 2019-013240

(51) Int. Cl. G06K 9/00; G06T 3/40; G06T 5/00; G06T 5/50

(52) U.S. Cl. CPC G06K 9/00281; G06K 9/00248; G06T 2207/30201; G06T 5/005; G06T 5/50; G06T 3/4038

(57) ABSTRACT

An image processing apparatus includes an image database, a communication device, and a control device. The image database stores image data that has been uploaded and enables sharing of the image data among users. The communication device performs data communication with the outside through a network. The control device functions as a searcher and an output device. The searcher searches the image database to extract a similar image that satisfies a condition that the similar image has an image portion with a high degree of identity with a designated image, which has been designated from a user terminal through the network via the communication device, at at least a predetermined ratio. The output device transmits similar image data of the similar image extracted by the searcher to the user terminal.

### INCORPORATION BY REFERENCE

This application claims priority to Japanese Patent Application No. 2019-013240 filed on Jan. 29, 2019, the entire contents of which are incorporated by reference herein.

### BACKGROUND

The present disclosure relates to an image processing apparatus and more particularly to a technique for searching an image database.

A variety of techniques for creating photo albums have been proposed. For example, a first technique involves increasing the size of a photo in which a large number of people are imaged such that their faces are recognized. A second technique involves identifying people from face information or bib information and selecting a photo of a target person.

A third technique involves allowing a reference point set in a layout frame that defines a range in which to insert a still image to match a target point set on a main subject to prevent the main subject from being left out from the layout frame.

### SUMMARY

One aspect of the present disclosure proposes a technique that is a further improvement on the above techniques.

An image processing apparatus according to one aspect of the present disclosure includes an image database, a communication device, and a control device. In the image database, image data having been uploaded is stored so as that the image data can be shared among users. The communication device performs data communication with the outside through a network. The control device includes a processor and functions as a searcher and an output device by the processor executing a control program. The searcher searches the image database to extract a similar image that satisfies a condition that the similar image has an image portion with a high degree of identity with a designated image at at least a predetermined ratio, the designated image being designated from a user terminal through the network via the communication device. The output device transmits similar image data of the similar image extracted by the searcher to the user terminal.

### BRIEF DESCRIPTION OF THE DRAWINGS

FIG. 1 is a diagram showing an entire image processing system including an image processing apparatus according to an embodiment of the present disclosure.

FIG. 2 is a functional block diagram schematically showing a main internal configuration of the image processing apparatus according to the embodiment of the present disclosure.

FIG. 3 is a diagram showing an example of a data configuration stored in a personal information storage device.

FIG. 4 is a diagram showing an example of a data configuration stored in an image database.

FIG. 5 is a flowchart showing an example of a process performed between a control device of the image processing apparatus and a user terminal according to an embodiment of the present disclosure.

FIG. 6A is a diagram showing an example of a designated image.

FIG. 6B is a diagram showing an example of a target facial image.

FIG. 6C is a diagram showing an example of a similar image.

FIGS. 7A, 7B and 7C are diagrams showing examples of similar images on which processing has been performed.

### DETAILED DESCRIPTION

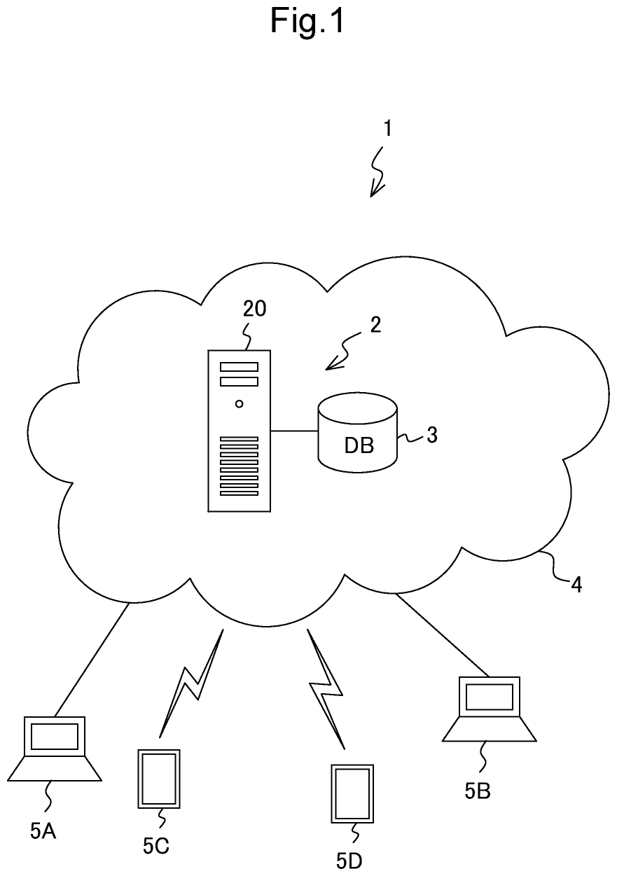

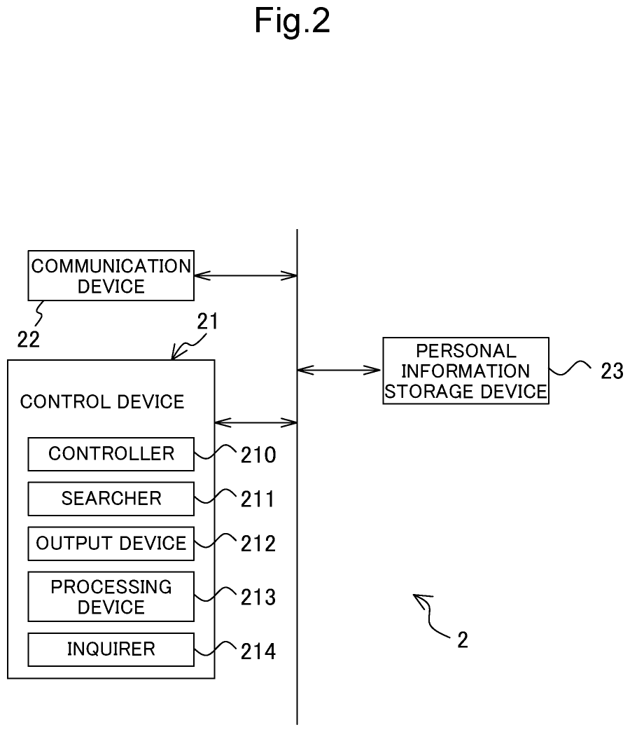

Hereinafter, an image processing apparatus according to an embodiment of the present disclosure will be described with reference to the drawings. FIG. 1 is a diagram showing an entire image processing system including the image processing apparatus according to the embodiment of the present disclosure. FIG. 2 is a functional block diagram schematically showing a main internal configuration of the image processing apparatus according to the embodiment of the present disclosure.

The image processing system 1 includes an image processing apparatus 2 present in a cloud 4 and a plurality of user terminals 5A to 5D (hereinafter also collectively referred to as “user terminals 5”). The image processing apparatus 2 includes an information processing apparatus 20 and an image database 3. The image processing apparatus 2 and the user terminals 5 are connected to each other through a network using the Internet. Examples of a user terminal 5 include a personal computer and a mobile device that can perform data communication through a network.

The information processing apparatus 20 is a server for realizing sharing of image data among members (individuals who are registered in the information processing apparatus 20). The image database 3 stores image data uploaded by each member such that the image data can be shared among members. The information processing apparatus 20 includes a control device 21, a communication device 22, and a personal information storage device 23.

The communication device 22 is a communication interface including a communication module that enables Internet communication or LAN communication. The communication device 22 performs data communication with the outside through the network. For example, the communication device 22 performs data communication with the image database 3 and the user terminals 5.

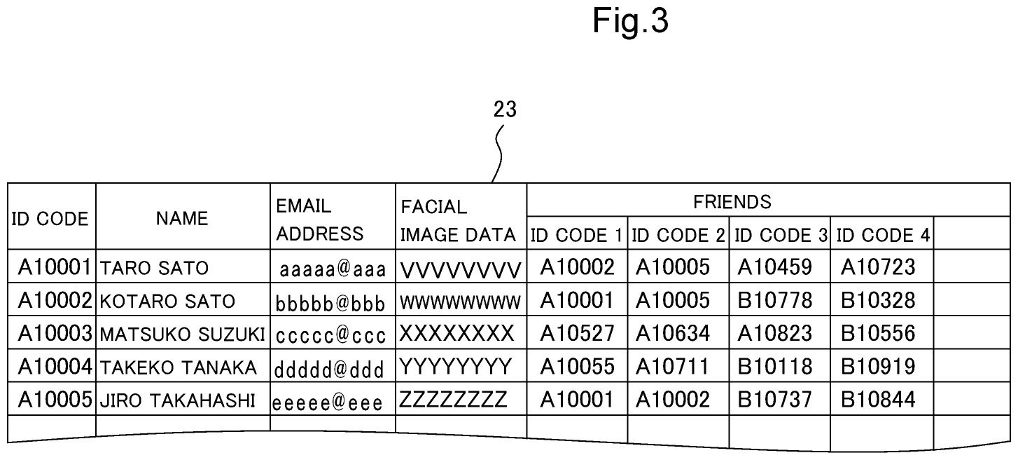

The personal information storage device 23 includes an HDD or the like and stores personal information of members in association with ID codes. FIG. 3 is a diagram showing an example of a data configuration of the personal information storage device 23. The personal information storage device 23 stores a name, an email address, facial image data, and ID codes of “friends” as personal information of each member in association with a corresponding ID code. “Friends” indicates a relationship with the member. “Friends” includes not only friends but also acquaintances, family members, relatives, and the like. Thus, not only ID codes of friends of the member but also ID codes of acquaintances, family members, relatives, and the like may be stored in the entries of “friends.” That is, ID codes stored as “friends” for a member in the personal information storage device 23 are relationship information indicating a “friend” relationship (an example of a predetermined relationship) of the member.

In the personal information storage device 23, ID codes “A10002” and “A10005” are stored in the entries of “friends” of an ID code “A10001.” Thus, information stored in the personal information storage device 23 indicates that “Taro Sato” with the ID code “A10001” has “friend” relationships with “Kotaro Sato” with the ID code “A10002” and “Jiro Takahashi” with the ID code “A10005.”

An ID code is an example of user identification information described in the claims. A method for registering personal information in the personal information storage device 23 will be described later.

The control device 21 is configured to include a processor, a random access memory (RAM), a read only memory (ROM), and a dedicated hardware circuit. The processor is, for example, a central processing unit (CPU), an application specific integrated circuit (ASIC), or a micro processing unit (MPU). The control device 21 includes a controller 210, a searcher 211, an output device 212, a processing device 213, and an inquirer 214.

The control device 21 functions as the controller 210, the searcher 211, the output device 212, the processing device 213, and the inquirer 214 through operations that the processor performs according to a control program stored in a hard disk drive (HDD) or the like (not shown). However, the controller 210 and the like can also be formed of respective hardware circuits rather than using operations that the control device 21 performs according to the control program. Hereinafter, the same applies to each embodiment unless otherwise specified.

The controller 210 is responsible for overall operation control of the information processing apparatus 20. The controller 210 is connected to the communication device 22 and the personal information storage device 23 and performs drive control and the like of these components. For example, upon receiving a member registration request from a user terminal 5 via the communication device 22, the controller 210 assigns an ID code to a user who has made the member registration request and requests the user terminal 5 to send personal information (for example, a name, an email address, and facial image data) via the communication device 22 and causes the personal information storage device 23 to store the personal information received from the user terminal 5 in association with the assigned ID code.

Upon receiving a request to register a new “friend” or to delete a “friend” from the user terminal 5 via the communication device 22, the controller 210 adds or deletes an ID code of the “friend” to or from corresponding personal information stored in the personal information storage device 23 on the basis of the request from the user terminal 5.

Further, a user terminal 5 transmits image data with an ID code of a user, who operates the user terminal, attached thereto to the information processing apparatus 20 through the network and requests that the image data be uploaded. Upon receiving the request via the communication device 22, the controller 210 assigns an image number to the uploaded image data and causes the image database 3 to store the uploaded image data and the ID code indicating the uploader (the user who has uploaded the image data) in association with the image number.

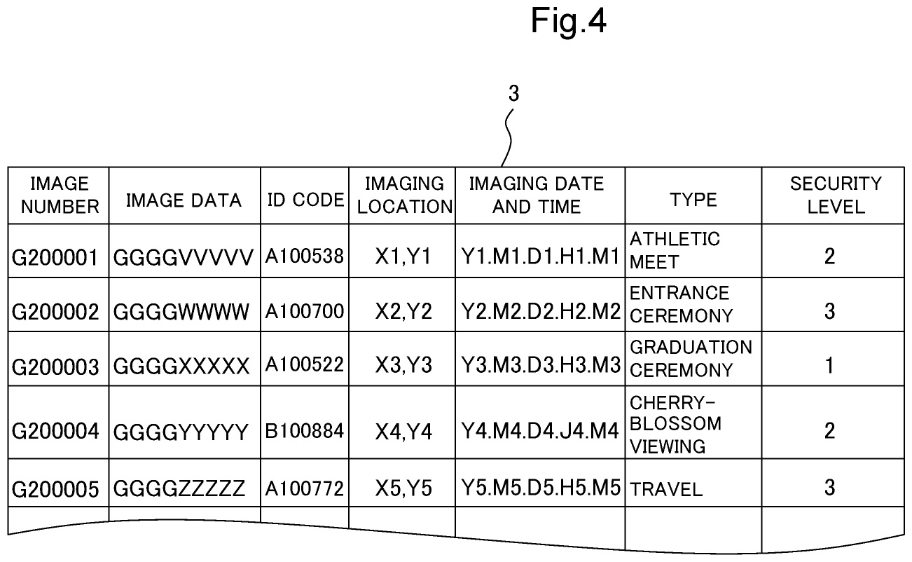

FIG. 4 is a diagram showing an example of a data configuration of the image database 3. The image database 3 stores uploaded image data, an uploader's ID code, an imaging location, an imaging date and time, a type, and a security level in association with each image number.

For example, some electronic devices having a camera function (for example, a mobile device such as a smartphone) have a GPS function and a clock function and automatically assign imaging location information and imaging date and time information to image data obtained by imaging with the electronic devices. Therefore, when image data is uploaded from such an electronic device to the information processing apparatus 20, imaging location information and imaging date and time information are uploaded to the information processing apparatus 20 together with the image data.

The type described above is the type of an image indicated by the image data. The type is, for example, an athletic meet, an entrance ceremony, a graduation ceremony, a cherry-blossom viewing, or travel and is set for each piece of image data by the user.

The security level described above is a value indicating the extent to which to secure the confidentiality of the image data. The security level is used to prevent infringement of privacy due to the uploaded image data being disclosed to third parties without restriction. A security level of “3” indicates a highest level in terms of securing the confidentiality, “2” indicates an intermediate level, and “1” indicates a lowest level.

The controller 210 requests the user terminal 5 of the uploader to set the type and security level of an image indicated by image data uploaded by the uploader via the communication device 22. Upon receiving content of the setting transmitted from the user terminal 5 of the uploader, the controller 210 updates storage content of the image database 3 according to the content of the setting. For example, the controller 210 transmits a prepared list of types (such as an athletic meet, an entrance ceremony, a graduation ceremony, a cherry-blossom viewing, and travel) to the user terminal 5 of the uploader and allows the uploader to select, from the list, the type of each piece of image data that he or she has uploaded. Similarly, the controller 210 allows the uploader to select the security level.

The searcher 211 searches the image database 3, for example, using a pattern matching technique to extract similar images that satisfy a condition that they have an image portion with a high degree of identity with a designated image which has been designated by the user terminal 5 at at least a predetermined ratio. The predetermined ratio is, for example, 70%. The searcher 211 extracts similar images on an additional condition that the similar images include a target facial image included in the designated image and designated by the user terminal 5 in addition to the above condition. For example, when a designated image together with a target facial image has been designated by the user terminal 5, the searcher 211 searches the image database 3 to extract images, which include a person of the target facial image and have an image portion with a high degree of identity with the designated image at at least the predetermined ratio, as similar images. The searcher 211 extracts a predetermined number of similar images in order from the one with the highest ratio (similarity). That is, the predetermined number is the number of similar images presented to the user.

The output device 212 transmits similar image data of the similar images extracted by the searcher 211 to the user terminal 5 via the communication device 22.

The processing device 213 performs predetermined processing for applying viewing restriction to image data stored in the image database 3. For example, the processing device 213 performs processing on similar image data of a similar image extracted by the searcher 211. Examples of the processing include applying a mosaic, blurring, applying a mask, or reducing image quality.

The inquirer 214 asks a notification destination (for example, an email address), which is stored in advance in the personal information storage device 23 in association with an uploader of the similar image data, if the uploader desires to cancel the processing via the communication device 22.

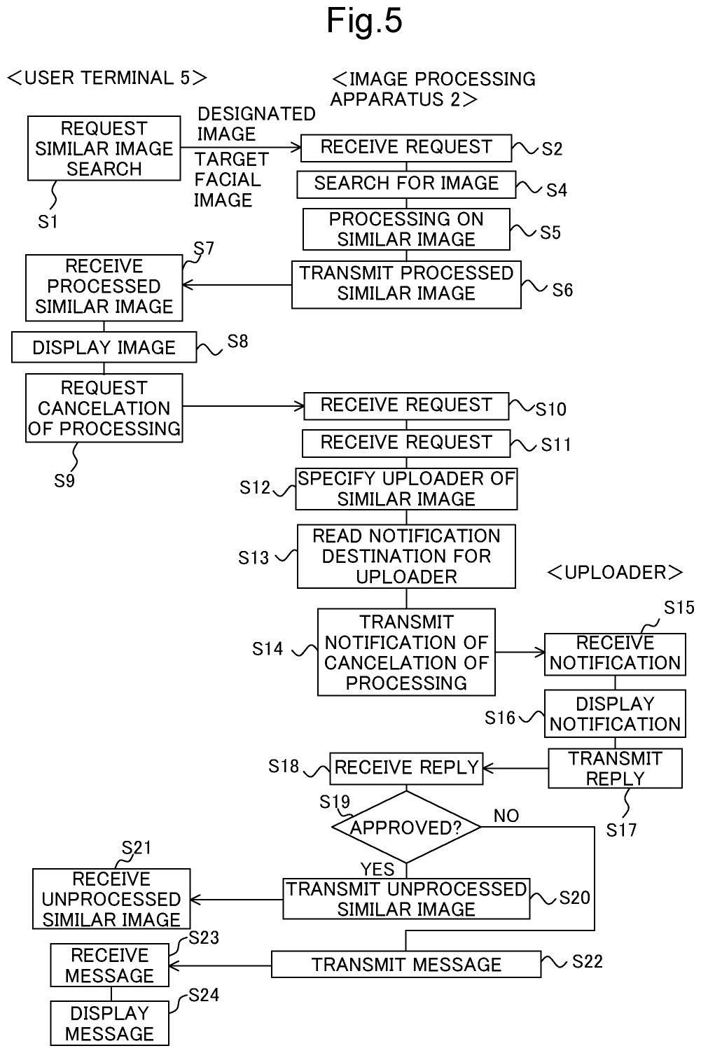

Next, an example of data exchange performed between the control device 21 of the information processing apparatus 20 and a user terminal 5 will be described based on a flowchart shown in FIG. 5.

The user terminal 5 accesses the image processing apparatus 2 through the network, designates an image and a target facial image, transmits an ID code of a user who operates the user terminal 5 from the user terminal 5 to the information processing apparatus 20, and requests the information processing apparatus 20 to search the image database 3 for an image similar to the designated image (S1).

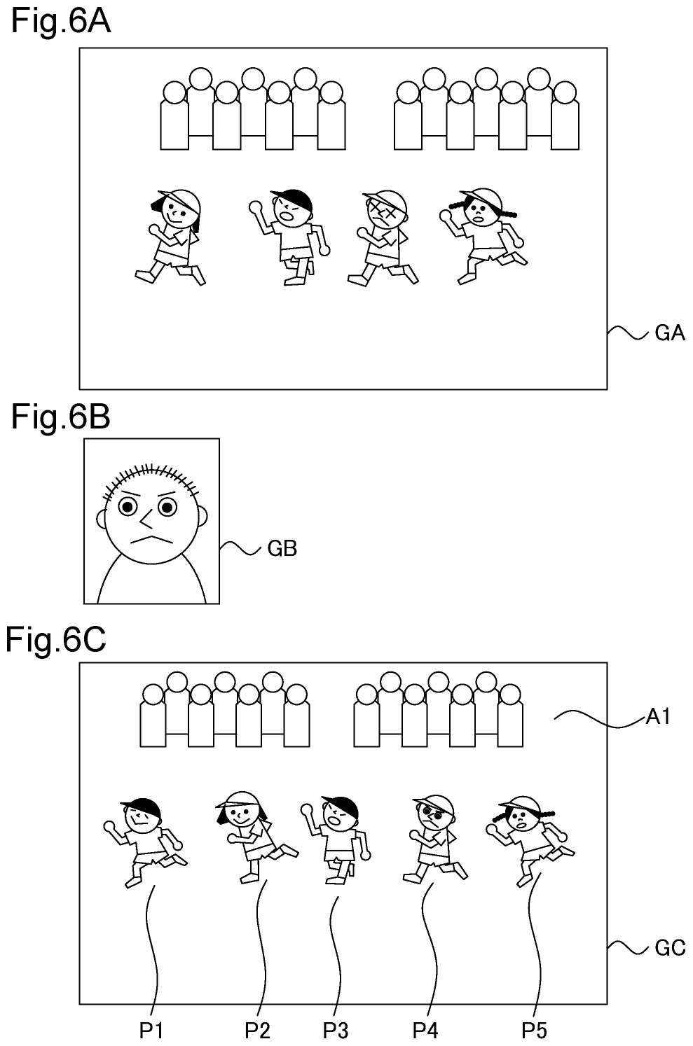

The following description will be given with reference to an example in which “Taro Sato” whose ID code is “A10001” has operated the user terminal 5 to designate an image as shown in FIG. 6A as a designated image GA and requested the search as described above.

A scene where four children are running is shown in the center of the designated image GA and many spectators are shown in the back. It is assumed that the second child from the right who is running with his eyes closed (the child whose eyes are crossed in FIG. 6A) is “Kotaro Sato.” It is also assumed that the designated image GA is a failed photo (image).

Examples of a method for designating the image GA at the user terminal 5 include a method in which the user accesses the image database 3 from the user terminal 5 and selects and designates an image from among images indicated by image data stored in the image database 3.

Examples of a method for designating the target facial image GB at the user terminal 5 include (1) a method in which the user accesses the image processing apparatus 2 from the user terminal 5 and selects and designates, through range designation, a desired facial image from among facial images included in images indicated by image data stored in the image database 3 and (2) a method in which the user accesses the image processing apparatus 2 from the user terminal 5 and selects and designates a desired facial image from among facial images of facial image data stored in the personal information storage device 23 of the information processing apparatus 20.

When the controller 210 of the information processing apparatus 20 has acquired designated image information indicating the designated image and target facial image information indicating the target facial image and the ID code of the user who has requested the search from the user terminal 5 or the image database 3 via the communication device 22 or from the personal information storage device 23 if the same have been designated using the personal information storage device 23 (S2), the searcher 211 searches the image database 3 to extract every image which includes a person of the target facial image indicated by the target facial image information and is similar to the designated image indicated by the designated image information (every image which satisfies the condition that it has an image portion with a high degree of identity with the designated image at at least a predetermined ratio) (S4).

In S1, the user terminal 5 may access the image processing apparatus 2 through the network, designate only the designated image, transmit the ID code of the user who operates the user terminal 5 from the user terminal 5 to the information processing apparatus 20, and request the information processing apparatus 20 to search the image database 3 for images similar to the designated image. In this case, when the controller 210 of the information processing apparatus 20 has acquired the designated image information and the ID code of the user (S2), the searcher 211 searches the image database 3 to extract every image which is similar to the designated image indicated by the designated image information (every image which satisfies the condition that it has an image portion with a high degree of identity with the designated image at at least a predetermined ratio) (S4).

If there are a plurality of similar images in S4, the searcher 211 extracts all similar images.

For example, if the user selects and designates a facial image of “Sato Kotaro” whose ID code is “A10002” (an example of the facial image is shown in FIG. 6B) as a desired facial image from among facial images of facial image data stored in the personal information storage device 23 using the user terminal 5 in S1, the searcher 211 extracts an image which includes the target facial image GB (the facial image of the person “Kotaro Sato”) and has an image portion with a high degree of identity with the designated image GA at at least the predetermined ratio (for example, an image whose composition is similar to that of the designated image GA) as a similar image. Thus, an image as shown in FIG. 6C is extracted as the similar image GC.

The controller 210 may receive designated target facial images of a plurality of people from the user terminal 5. When the controller 210 has received target facial images of a plurality of people, the searcher 211 extracts an image including all people of the target facial images as a similar image. The searcher 211 preferably searches for an image in which a target facial image(s) is in focus as a similar image. For example, the searcher 211 determines that a target facial image is in focus when the contrast in the target facial image is greater than or equal to a predetermined threshold.

A scene where five children (persons P1 to P5) are running is shown in the center of the similar image GC shown in FIG. 6C and many spectators A1 are shown in the back of the similar image GC, whose composition is similar to that of the designated image GA. The person P4 is “Kotaro Sato” with the ID code “A10002.” That is, the person P4 is the person of the target facial image GB and is shown in the similar image GC.

An existing method using local feature values may be employed as a method for searching for images similar to the designated image GA. Examples of a method of searching for a person of the target facial image GB include an existing method using a face recognition technique.

As another embodiment, the searcher 211 may search the image database 3 to extract similar images with imaging location information or imaging date and time information added as a search condition. For example, the searcher 211 reads imaging location information or imaging date and time information about the designated image GA from the image database 3 and searches the image database 3 to extract similar images by narrowing them down to images taken within a radius of 20 m from the location where the designated image GA was taken or images taken within 5 minutes before and after the date and time when the designated image GA was taken. The searcher 211 reads imaging location information or imaging date and time information of similar images from the image database 3.

Further, the controller 210 may receive additional search condition settings from the user through the user terminal 5 and the searcher 211 may search the image database 3 on the basis of the search conditions set by the user to extract similar images.

For example, the searcher 211 searches the image database 3 to extract similar images by narrowing them down to images that match a type set by the user (for example, an athletic meet) that the controller 210 has received as a search condition. If there are a plurality of images whose identity reaches the ratio described above, the searcher 211 may extract similar images in descending order of the ratio, i.e., in descending order of similarity on the basis of a number of images to be presented which the controller 210 has received as a search condition such that the number of similar images extracted is limited to the number of images to be presented.

Subsequently, the processing device 213 performs processing corresponding to viewing restriction according to a security level set for similar image data indicating the similar image extracted by the searcher 211 (S5).

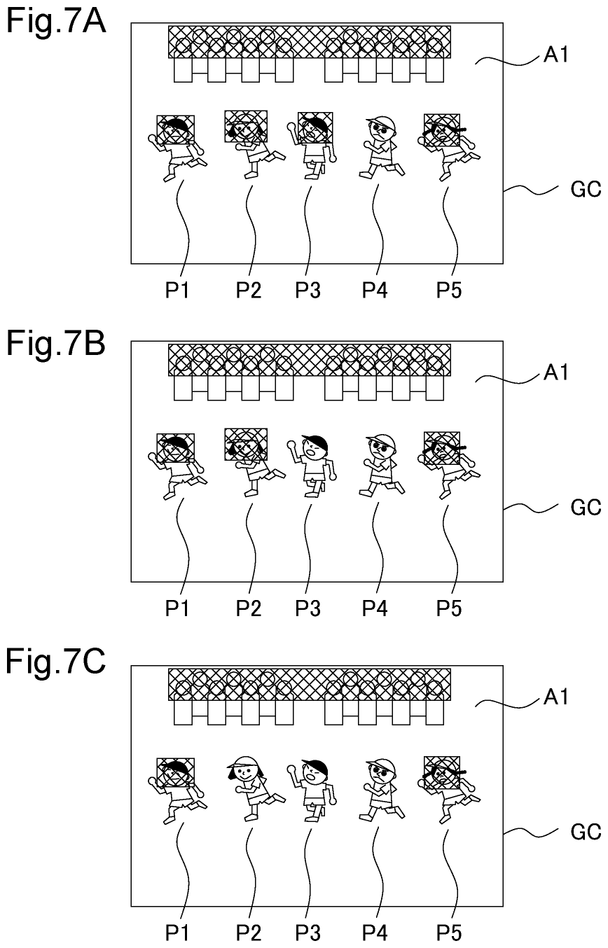

For example, when the security level set for the similar image is “3” which is the highest level, the processing device 213 performs processing on facial images of people included in the similar image GC except for the person of the target facial image GB. When the similar image extracted by the searcher 211 is the similar image GC shown in FIG. 6C, the processing device 213 performs processing on facial images of people included in the similar image GC except for the person P4 (the person of the target facial image GB). For example, the processing device 213 performs mosaic processing such that the faces of the persons P1 to P3 and P5 and the spectators A1 are not recognized as shown in FIG. 7A.

When the security level is “2” which is the intermediate level, based on the above-described relationship between users (between members) stored in the personal information storage device 23, the processing device 213 specifies a person having a predetermined relationship with the user who has designated the designated image GA and performs processing on facial images of people included in the similar image GC except for the person of the target facial image GB and the specified person.

For example, when the persons P2 to P4 among the persons P1 to P5 shown in the similar image GC have been registered in the personal information storage device 23, the person P2 is “Matsuko Suzuki” with the ID code “A10003,” the person P3 is “Jiro Takahashi” with the ID code “A10005,” and the person P4 is “Kotaro Sato” with the ID code “A10002,” the person P3 with the ID code “A10005” and the person P4 with the ID code “A10002” have a “friend” relationship with the user with the ID code “A10001” who has designated the designated image GA.

Therefore, when the similar image extracted by the searcher 211 is the similar image GC shown in FIG. 6C, the processing device 213 specifies the persons P3 and P4 as persons having the predetermined relationship with the user who has designated the designated image GA and performs processing on the facial images of people included in the similar image GC except for the person P4 (the person of the target facial image GB) and the specified persons P3 and P4. For example, the processing device 213 performs mosaic processing such that the faces of the persons P1, P2, and P5 and the spectators A1 are not recognized as shown in FIG. 7B. Note that, while the person P4 is the person of the target facial image GB and has a “friend” relationship with the user, the person P4 is originally not a target of the processing because he is the person of the target facial image GB.

When the security level is “1,” which is the lowest level, the processing device 213 performs processing on facial images of people included in the similar image GC except for the person of the target facial image GB and people stored in the personal information storage device 23 (regardless of the relationship with the user who has designated the designated image GA). For example, when the similar image extracted by the searcher 211 is the similar image GC shown in FIG. 6C, the processing device 213 performs processing on facial images of people included in the similar image GC except for the person P4 (the person of the target facial image GB) and the persons P2 to P4 registered as members. For example, the processing device 213 performs mosaic processing such that the faces of the persons P1 and P5 and the spectators A1 are not recognized as shown in FIG. 7C.

The processing device 213 may also collate facial images of the spectators A1 and not perform processing on people who have a “friend” relationship with the user who has designated the designated image GA and people registered in the personal information storage device 23 among the spectators A1.

Subsequently, the output device 212 attaches the image number of the similar image data on which the processing device 213 has performed the processing to the similar image data and transmits the similar image data with the image number attached thereto to the user terminal 5 which has requested the similar image search in S1 via the communication device 22 (S6).

Upon receiving the similar image data transmitted from the information processing apparatus 20 (S7), the user terminal 5 displays the received similar image data on a display device of the user terminal 5 such that the user can select a similar image indicated by the similar image data (S8). If there are a plurality of similar images, the user terminal 5 displays a list of similar images on the display device.

The user terminal 5 transmits an image number attached to similar image data of a similar image selected by the user to the information processing apparatus 20 as the user's selection result and requests the information processing apparatus 20 to cancel the processing performed on the similar image data (S9). Note that, when the user terminal 5 has received an instruction to save the similar image selected by the user in the user terminal 5 as the user's selection result, the user terminal 5 stores the similar image data in the user terminal 5 and the subsequent processes are not performed.

In the information processing apparatus 20, the communication device 22 receives the image number as the selection result from the user terminal 5 and also receives the request to cancel the processing (S10). When the controller 210 has received the request to cancel the processing (S11), the inquirer 214 reads an ID code associated with the image number received from the user terminal 5 (the ID code of the uploader of the similar image data) from the image database 3 and specifies the uploader (S12) and reads a notification destination associated with the read ID code (for example, an email address registered in advance for the uploader) from the personal information storage device 23 (S13).

Thereafter, the inquirer 214 provides the read notification destination with a notification asking if cancellation of the processing is desired via the communication device 22 (S14).

Upon receiving the notification from the information processing apparatus 20 (S15), a terminal device used by the uploader of the similar image, which is the notification destination, displays the received notification on a display device of the terminal device (S16). Upon receiving a reply to the notification from the uploader of the similar image, the terminal device transmits the reply to the information processing apparatus 20 (S17).

In the information processing apparatus 20, when the communication device 22 has received the reply from the uploader of the similar image (S18), the output device 212 determines whether or not the received reply indicates approval of cancellation of the processing (S19).

Upon determining that the received reply indicates approval of cancellation of the processing (YES in S19), the output device 212 transmits image data corresponding to the image number transmitted from the user terminal 5 (that is, the similar image data) to the user terminal 5 that has requested the similar image search in S1 via the communication device 22 without the processing device 213 performing processing on the image data (S20).

The user terminal 5 that has requested the similar image search in S1 receives the similar image data, on which processing has not been performed, transmitted from the information processing apparatus 20 (S21). The user terminal 5 stores the similar image data in the user terminal 5 on the basis of an instruction from the user.

On the other hand, in the information processing apparatus 20, upon determining that the received reply does not indicate approval of cancellation of the processing (NO in S19), the output device 212 transmits a message such as “the processing cannot be canceled” to the user terminal 5 which has requested the similar image search in S1 via the communication device 22 (S22).

Upon receiving the message transmitted from the information processing apparatus 20 (S23), the user terminal 5 that has requested the similar image search in S1 displays the received message on the display device of the user terminal 5 (S24). The user terminal 5 stores the similar image data in the user terminal 5 on the basis of an instruction from the user.

According to the above embodiment, a similar image GC which is similar to a designated image GA (for example, a failed photo) that has been designated from the user terminal 5 (for example, a photo whose composition is similar to that of the failed photo) is extracted from various image data uploaded to the image database 3 and similar image data of the extracted similar image GC is transmitted to the user terminal 5. Accordingly, the user can acquire a better image, which replaces the designated image GA that has been designated by the user, from the uploaded image data.

It is also possible to prevent privacy infringement since processing is performed on the similar image data of the similar image GC transmitted to the user terminal 5 in an initial stage. In addition, the user can acquire a similar image GC that has not been processed since the uploader of the similar image data is asked if he or she desires to cancel the processing and the processing is canceled if the uploader approves cancellation of the processing.

Incidentally, the use of social networking services (SNSs) has expanded in recent years and a large amount of photo data (image data) uploaded by many people exists on the Internet such as on the cloud. However, photography at an event such as an athletic meet may fail to yield photos that do not satisfy the user such as those that are out of focus, those in which the eyes of a target person (for example, the photographer's child) are closed, and those with an unsatisfactory facial expression. The user will be happy if they can acquire a photo that replaces a failed photo (for example, a photo that has the same imaging location as the failed photo and satisfactorily shows the target person) from among a large number of uploaded photos. However, it is not easy to find a photo that satisfies the user from a large number of photos. None of the first to third techniques described above in the related art acquires a photo that replaces a failed photo from uploaded photos.

On the other hand, the present embodiment allows the user to acquire an image that replaces an image (for example, a failed photo) designated by the user from uploaded image data.

The present disclosure is not limited to the configuration of the above embodiment and various modifications can be made. Moreover, in the above embodiment, the structures and processes shown using FIGS. 1 to 7C are merely examples of the present disclosure and are not intended to limit the disclosure to the structures and processes.

While the present disclosure has been described in detail with reference to the embodiments thereof, it would be apparent to those skilled in the art the various changes and modifications may be made therein within the scope defined by the appended claims.

What is claimed is:

1. An image processing apparatus comprising:
an image database in which image data having been uploaded is stored so as that the image data can be shared among users;
a communication device configured to perform data communication with an outside through a network; and
a control device including a processor and configured to, by the processor executing a control program, function as:
a searcher configured to search the image database to extract a similar image that satisfies a condition that the similar image has an image portion with a high degree of identity with a designated image at at least a predetermined ratio, the designated image being designated from a user terminal through the network via the communication device; and
an output device configured to transmit similar image data of the similar image extracted by the searcher to the user terminal.

2. The image processing apparatus according to claim 1, wherein the searcher is configured to extract the similar image on a condition that the similar image includes a target facial image included in the designated image and designated from the user terminal in addition to the condition.

3. The image processing apparatus according to claim 2, wherein the searcher is configured to, when the target facial image is designated from the user terminal for a plurality of persons, extract as the similar image an image including the target facial image for all of the plurality of persons.

4. The image processing apparatus according to claim 1, wherein the searcher is configured to extract as the similar image an image in which a target facial image is in focus.

5. The image processing apparatus according to claim 1, wherein the control device is configured to, by the processor executing the control program, further function as:
a processing device configured to perform predetermined processing to apply viewing restriction to the image data stored in the image database, and
the output device is configured to transmit to the user terminal, as the similar image data, the image data on which the processing device has performed the processing.

6. The image processing apparatus according to claim 5, wherein the control device is configured to, by the processor executing the control program, further function as a controller configured to set one of a plurality of security levels for each piece of the image data respectively, and
the processing device is configured to perform processing corresponding to the viewing restriction according to the security level that the controller has set for the image data.

7. The image processing apparatus according to claim 6, wherein the controller is configured to set one of the plurality of security levels for each piece of the image data respectively, and
the processing device is configured to perform the processing on a facial image, of a person, included in the similar image except for a target facial image when the security level set for the image data is a predetermined highest level.

8. The image processing apparatus according to claim 7, further comprising a personal information storage device configured to store facial image data of users, user identification information associated with the facial image data, and relationship information indicating a relationship between users,
when the security level is a predetermined lowest level, the processing device is configured to perform the processing on a facial image of a person included in the similar image except for a person of the target facial image and a person of the facial image data stored in the personal information storage device, and
when the security level is a predetermined intermediate level between the highest and lowest levels, the processing device is configured to specify a person indicating a predetermined relationship with a user who has designated the designated image on the basis of the relationship information and perform the processing on a facial image of a person included in the similar image except for the person of the target facial image and the specified person.

9. The image processing apparatus according to claim 6, wherein the processing is one of applying a mosaic, blurring, masking, or reducing image quality.

10. The image processing apparatus according to claim 8, wherein the personal information storage device is configured to store an uploader of the image data and a notification destination for the uploader,
the control device is configured to, by the processor executing the control program, further function as an inquirer configured to ask, on the basis of information stored in the personal information storage device, a notification destination for an uploader of the similar image data if the uploader desires to cancel the processing via the communication device, and
the output device is configured to transmit to the user terminal the similar image data on which the processing has not been performed when the communication device has received a reply indicating approval of the cancellation transmitted from the notification destination.

11. The image processing apparatus according to claim 1, wherein the searcher is configured to extract a predetermined number of the similar images in descending order of the ratio.

12. The image processing apparatus according to claim 1, wherein imaging location information or imaging date and time information is added as the condition and the searcher is configured to search the image database to extract the similar image on a condition that the similar image includes the imaging location information or the imaging date and time information.
